(19) United States
(12) Patent Application Publication
(10) Pub. No.: US 2026/0203692 A1
(43) Pub. Date: Jul. 16, 2026

(54) Managing Workflow Instance Execution using a Workflow Sentinel

(71) Applicant: International Business Machines Corporation, Armonk, NY (US)

(72) Inventors: Richard James McCarty, Austin, TX (US); Pradeep Kadiyala, Austin, TX (US)

(21) Appl. No.: 19/023,183

(22) Filed: Jan. 15, 2025

(51) Int. Cl. G06Q 10/0633

(52) U.S. Cl. CPC G06Q 10/0633

(57) ABSTRACT

Managing workflows is provided. A comparison of a directed graph of a current instance of a workflow with a stored directed graph of a previously learned instance of the workflow is performed. It is determined whether a workflow variant exists between the current instance of the workflow and the previously learned instance of the workflow based on the comparison. In response to determining that the workflow variant does exist between the current instance of the workflow and the previously learned instance of the workflow based on the comparison, the workflow variant is added to the stored directed graph of the previously learned instance of the workflow to form a learned workflow variant of the workflow.

### BACKGROUND

The disclosure relates generally to workflows and more specifically to managing workflows.

A workflow is a sequence of steps from initiation to completion designed to accomplish a specific goal or objective. In other words, the sequence of steps is performed in a specific order to accomplish the goal. Thus, a workflow executes the steps in a particular order. Entities, such as, for example, enterprises, companies, businesses, organizations, institutions, agencies, and the like, utilize workflows to accomplish their goals (e.g., provide services, process transactions, process data, manufacture products, or the like).

### SUMMARY

According to one illustrative embodiment, a computer-implemented method is provided. The computer-implemented method performs a comparison of a directed graph of a current instance of a workflow with a stored directed graph of a previously learned instance of the workflow. The computer-implemented method determines whether a workflow variant exists between the current instance of the workflow and the previously learned instance of the workflow based on the comparison. In response to determining that the workflow variant does exist between the current instance of the workflow and the previously learned instance of the workflow based on the comparison, the computer-implemented method adds the workflow variant to the stored directed graph of the previously learned instance of the workflow to form a learned workflow variant of the workflow. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a workflow management system in accordance with an illustrative embodiment;

FIG. 3 is a diagram illustrating an example of a workflow in accordance with an illustrative embodiment;

FIG. 4 is a diagram illustrating an example of a learned workflow directed graph in accordance with an illustrative embodiment;

FIG. 5 is a diagram illustrating an example of a step signal attribute table in accordance with an illustrative embodiment;

FIG. 6 is a diagram illustrating an example of an instantiated workflow monitoring process in accordance with an illustrative embodiment;

FIG. 7 is a diagram illustrating an example of a completed workflow assimilation into a learned workflow process in accordance with an illustrative embodiment;

FIG. 8 is a diagram illustrating an example of a learned workflow variant identification process in accordance with an illustrative embodiment; and

FIGS. 9A-9B are a flowchart illustrating a process for managing workflows in accordance with an illustrative embodiment.

### DETAILED DESCRIPTION

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation or garbage collection, but this does not render the storage device as transitory because the data is not transitory while it is stored.

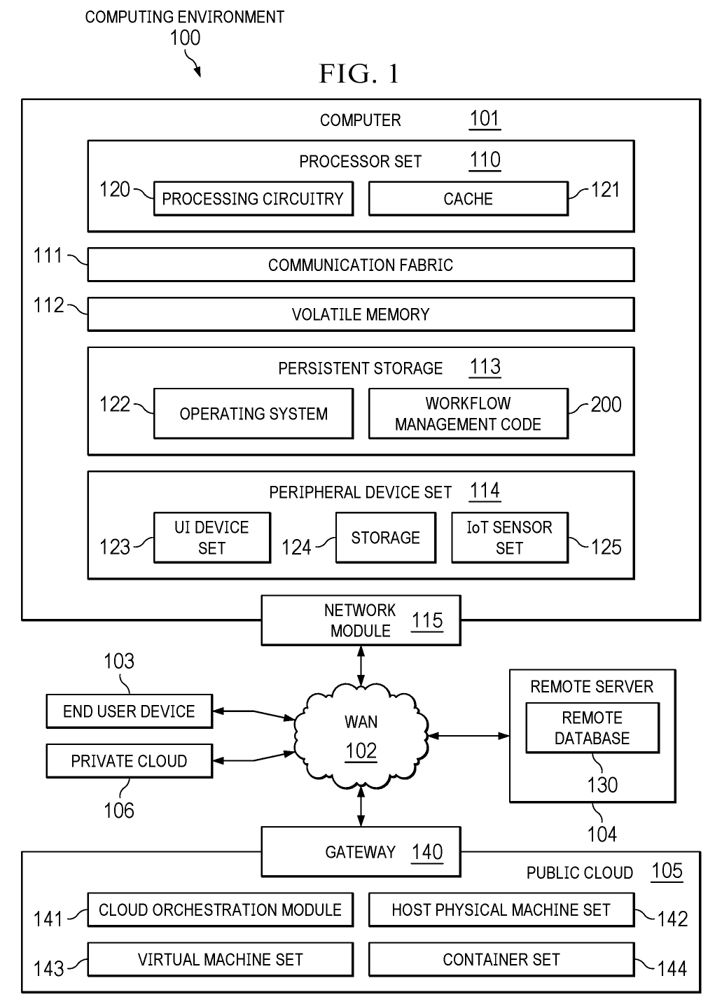

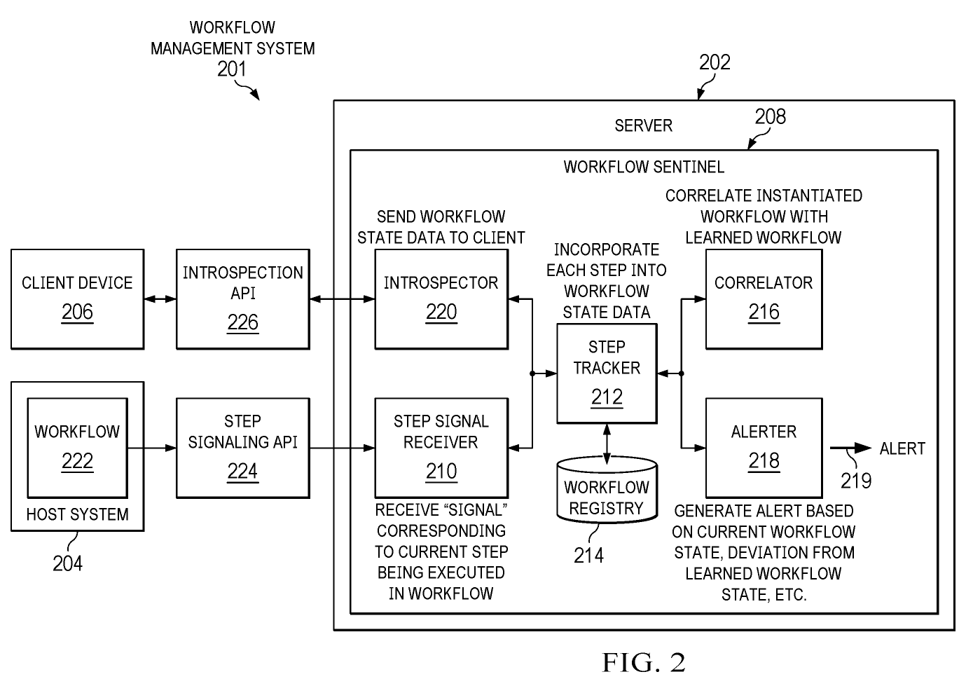

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as workflow management code 200.

For example, workflow management code 200 tracks and manages workflow instance execution, with estimated duration of each respective step in the workflow instance and expected path through the steps in the workflow instance based on recorded past instantiations of the workflow. Workflow management code 200 also learns workflows dynamically, including logical alternatives or variations in a learned workflow. In addition, through introspection, workflow management code 200 enables visualization of real time execution of instantiated workflows and learned workflows.

Workflow management code 200 represents workflows using data structures such as directed graphs (e.g., cyclic directed graphs) or the like. Further, workflow management code 200 operates independently of underlying workflow implementations (e.g., sequential workflows or state machine-based workflows). Clients can utilize workflow management code 200 to provision services (e.g., Software-as-a-Service, Infrastructure-as-a-Service, and the like), but can also utilize workflow management code 200 for various other types of workflows, such as monitoring and recovery workflows, general process automation workflows, and the like.

A workflow is a repeatable and predictable process expressed as an orchestrated series of sequential steps. Each step of a workflow is comprised of a set of one or more tasks, operations, activities, processes, or the like. However, it should be noted that workflow management code 200 is not concerned with what tasks are being executed in each respective step. Instead, workflow management code 200 is concerned with which step is being executed in the workflow and whether the current step has been completed or not.

The workflow generates and sends a “step signal” corresponding to the current step being executed in the workflow and forwards the step signal via a step signal receiver to a workflow sentinel implemented by workflow management code 200. The workflow sentinel of workflow management code 200 instantiates and records each respective step as the workflow executes.

However, it should be noted that executing workflow steps do not necessarily need to communicate directly with the workflow sentinel of workflow management code 200. Alternative illustrative embodiments may use an intermediary workflow observer, which may be, for example, a software agent or some type of process engine, to generate and forward workflow step signals. Within a workflow registry, workflow management code 200 represents workflows and their workflow instance variations as data structures (e.g., directed graphs or the like) linking nodes and edges and associating the nodes and edges with corresponding attributes, features, properties, or characteristics, which may be provided by, for example, a graph database.

In addition to workflow management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and workflow management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in workflow management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a client who utilizes the workflow management services provided by computer 101), and may take any of the forms discussed above in connection with computer 101. EUD 103 typically receives helpful and useful data from the operations of computer 101. For example, in a hypothetical case where computer 101 is designed to provide a workflow management recommendation to the end user, this recommendation would typically be communicated from network module 115 of computer 101 through WAN 102 to EUD 103. In this way, EUD 103 can display, or otherwise present, the workflow management recommendation to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a workflow management recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Consider a computing environment supporting multiple simultaneously executing workflows, especially in a provisioning context, for such things as service configuration, end user access, and the like. Generally, such workflows are executed asynchronously, often with a client (e.g., a user, customer, or the like) waiting for the provisioning of, for example, purchased services or software to be completed. Further, should a step in a workflow become stalled or fail, it is often difficult for such conditions to be detected in a timely manner.

Additionally, within a large, diverse computing environment, workflows may be implemented in a variety of forms, utilizing various underlying technologies, which do not have sufficient interfaces for monitoring workflow execution and alerting to initiate workflow recovery actions. This can be especially true in large, diverse cloud environments, where workflow-driven provisioning activities are constantly in process.

Typically, workflows conform to one of two workflow models, sequential workflows and state machine workflows. In a sequential workflow, each step in the workflow is dependent on, and controlled by, its predecessor step. In other words, steps in a sequential workflow are executed one after another, beginning to end. However, branching can exist in a sequential workflow. A state machine workflow is managed through a series of states and transitions, which do not necessarily correspond to specific steps. Such state machine workflows provide more flexibility than sequential workflows. Also, sequential workflows can be modeled by a state machine workflow, but the reverse is not true.

Irrespective of the workflow model, from the perspective of a client waiting for a given workflow to complete, the workflow can be viewed as a series of steps which need to be executed. Whether the underlying implementation is sequential or state machine-driven, any workflow can be abstracted from such a series of steps.

Illustrative embodiments provide the ability to know whether a given workflow is processing normally, to trigger an alert when out-of-parameter workflow conditions are detected, and to provide a client visibility into how the workflow is proceeding in real time. Such capabilities may be important in a variety of scenarios, but especially so in situations where a client has purchased a service or software which requires provisioning. It is not unusual for errors or failures to occur during such provisioning workflows, and for clients to be left not knowing what is happening or to not be provided with an estimated time for workflow completion.

Illustrative embodiments utilize a workflow sentinel that dynamically generates a representation (e.g., directed graph) of a workflow in responsive to receiving inputs of step signals from an executing instance of the workflow. With respect to the workflow instance, illustrative embodiments compare the steps of that workflow instance against previously recorded or learned instances of that same workflow to determine: 1) whether one or more steps in that workflow instance deviate from previously recorded instances of that same workflow (e.g., that workflow instance is taking one or more alternate paths); and 2) whether the duration of one or more steps in that workflow instance deviate from step durations in the previously recorded instances of that same workflow.

Using data ascertained from comparing the currently executing workflow instance against the previously recorded instances of that same workflow, illustrative embodiments can estimate time to completion of a currently executing step in that workflow instance, estimate total time to completion of that workflow instance, and predict remaining steps in that workflow instance, including potential alternate paths with indications of which path is more likely.

Essentially, the workflow sentinel of illustrative embodiments learns and records previously completed workflow instances and then uses the data corresponding to the previously completed workflow instances to dynamically build a data structure or model (e.g., a directed graph) of the workflow. In recording workflows, the workflow sentinel represents not only the steps in a particular workflow including step timings (e.g., durations), but also observes the paths through that particular workflow including any variations. As the workflow sentinel observes more instances of that particular workflow over time, the workflow sentinel can continually refine the learned workflow data. For example, the workflow sentinel can record previously unobserved alternate paths in that particular workflow and adjust timing data for steps in that particular workflow as needed. When the workflow sentinel first observes a given workflow no recorded information exits regarding that particular workflow. In that case, the workflow sentinel will record the steps of the workflow as the workflow sentinel observes execution of that workflow.

Using a generated data structure (e.g., directed graph) of a workflow, the workflow sentinel can evaluate the processing of actively executing instances of that particular workflow, determine the expected path (e.g., set of steps) needed to complete that particular workflow, and provide an estimated time of completion for that particular workflow instance. As a result, the workflow sentinel of illustrative embodiments provides a way to track execution of workflows, with estimated timing of respective steps and expected path through the steps of respective workflows. Further, the workflow sentinel automatically learns workflows, including any alternative paths in the workflows. Furthermore, the workflow sentinel enables clients to visualize workflows and the real time execution of instantiated workflows via an introspection API. Moreover, it should be noted that the workflow sentinel is workflow implementation agnostic and can be used in computing environments where multiple differing workflow technologies or mechanisms are utilized, which is common in provisioning services and the like.

Thus, illustrative embodiments provide one or more technical solutions that overcome a technical problem with existing workflow monitoring solutions that do not have sufficient interfaces for monitoring workflow execution and alerting to initiate workflow recovery actions for workflows that are implemented in a variety of forms and utilize various underlying technologies. As a result, these one or more technical solutions provide a technical effect and practical application in the field of automated workflow management.

With reference now to FIG. 2, a diagram illustrating an example of a workflow management system is depicted in accordance with an illustrative embodiment. Workflow management system 201 may be implemented in a computing environment, such as computing environment 100 in FIG. 1. Workflow management system 201 is a system of hardware and software components for managing automated workflows that are implemented in a variety of forms and utilize various underlying technologies.

In this example, workflow management system 201 includes server 202, host system 204 and client device 206. Server 202 may be, for example, computer 101 in FIG. 1. Host system 204 may be, for example, one of host physical machine set 142 or virtual machine set 143 in FIG. 1. Client device 206 may be, for example, EUD 103 in FIG. 1. However, it should be noted that workflow management system 201 is intended as an example only and not as a limitation on illustrative embodiments. For example, workflow management system 201 can include any number of servers, host systems, client devices, and other devices and components not shown.

Server 202 includes workflow sentinel 208. Workflow sentinel 208 may be implemented by workflow management code 200 in FIG. 1. In this example, workflow sentinel 208 is comprised of step signal receiver 210, step tracker 212, workflow registry 214, correlator 216, alerter 218, and introspector 220. However, it should be noted that workflow sentinel 208 is intended as an example only and may include more or fewer components than shown. For example, workflow sentinel 208 may combine two or more components into one component, separate one component into two or more components, delete one or more components, or add one or more components.

Step signal receiver 210 receives a “signal” corresponding to the current step being executed in workflow 222 via step signaling API 224. Step signaling API 224 may be located on host system 204 or may be located on a separate host. Workflow 222 runs on host system 204. Workflow 222 may represent any type of automated workflow, such as provisioning a service for an entity corresponding to client device 206. Workflow 222 is comprised of a plurality of steps. The received signal indicates which step in the plurality of steps comprising workflow 222 is currently being executed by host system 204. Also, it should be noted that workflow 222 may represent a set of workflows running on host system 204.

Moreover, step tracker 212 monitors the step time duration of each respective step in the instantiated workflow to determine whether the step time duration exceeds a maximum step time duration threshold for that particular step. Step tracker 212 can determine the maximum step time duration threshold based on a combination of learned workflow behavior and estimated or average step time duration of that particular step with an allowance for a defined amount of variance. The defined amount of variance may be, for example, a set percentage of the estimated or average time duration for that particular step. The set percentage may be, for example, 25%, 30%, 40%, 50%, 60%, 70%, 75%, or the like. Step tracker 212 also monitors workflow completion times and other relevant data for executing workflow instances. Step tracker 212 can direct workflow sentinel 208 to perform remediation actions when time duration of a particular step exceeds the maximum time duration threshold level for that particular step or when the completion time of that particular workflow exceeds a predicted completion time for that particular workflow.

Correlator 216 correlates instantiated workflows, such as workflow 222, with learned workflows stored in workflow registry 214. For example, correlator 216, in conjunction with step tracker 212, compares data from previously learned workflows against data from current instantiations of these workflows to detect changes to the steps of the previously learned workflows. For example, when a new step not previously seen in a prior instantiation of a learned workflow is executed, correlator 216 detects the new step and updates the learned workflow accordingly. Step tracker 212 invokes correlator 216 when an instantiation of a workflow deviates from the existing learned workflow, or a new, previously unknown workflow is instantiated. Correlator 216 also identifies “variant” flow patterns corresponding to a particular workflow.

Furthermore, correlator 216 can assimilate a completed instantiated workflow into a learned workflow. For example, correlator 216 can update average step time durations of a learned workflow based on the step time durations of the completed instantiated workflow. However, if a learned workflow does not currently exist, then correlator 216 generates a learned workflow from the completed workflow instance. In addition, it should be noted that when a completed workflow instance has a path through any new steps not previously seen, even a series of steps ending as a failure, correlator 216 can assimilate those steps into a learned workflow.

Alerter 218 generates alert 219 based on current workflow state, deviation from learned workflow state, and the like. For example, alerter 218 generates alert 219 for an instantiated workflow when step signal receiver 210 receives a certain step signal from the instantiated workflow or when step tracker 212 detects that some actionable condition exists during execution of the instantiated workflow. Alert 219 can be informational (e.g., a PagerDuty alert with workflow ID, workflow instance ID, current step, and alert reason) or can trigger one or more remediation actions corresponding to the instantiated workflow. For example, alert 219 can trigger workflow sentinel 208 to perform an automated recovery process for a failed workflow or execute security measures, such as terminate network connects, for a compromised workflow.

Introspector 220 sends workflow state data to client device 206 via introspection API 226. For example, introspector 220 provides an interface for introspection of both instantiated workflows and learned workflows. Introspector 220 may be, for example, an API introspection service that provides data (e.g., directed graphs with node and edge properties, step signal attributes, step signal values, step signal descriptions, and the like) corresponding to workflows in a format that can be presented via a graphical user interface or other type of user interface on client device 206. Alternatively, the format for the workflow data can be in printed form, such as a printed report. Introspection API 226 is responsive to requests from client device 206 for data corresponding to the current real time status of an executing workflow, such as workflow 222, or information regarding previously learned workflows.

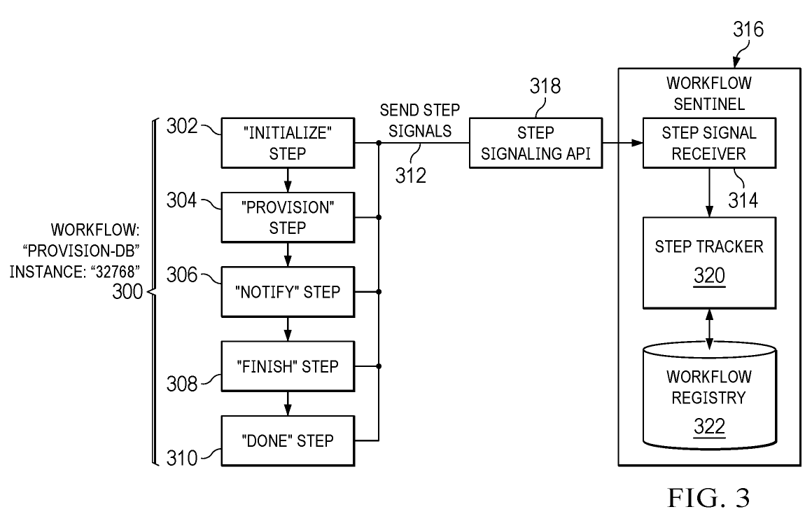

With reference now to FIG. 3, a diagram illustrating an example of a workflow is depicted in accordance with an illustrative embodiment. Workflow 300 may be, for example, workflow 222 in FIG. 2.

In this example, workflow 300 is a particular workflow instance for provisioning a database and is comprised of a plurality of steps. In this example, the plurality of steps includes initialize step 302, provision step 304, notify step 306, finish step 308, and done step 310. However, it should be noted that workflow 300 is intended as an example only and may include any number of steps.

At 312, workflow 300 individually sends each of step signals corresponding to initialize step 302, provision step 304, notify step 306, finish step 308, and done step 310 to step signal receiver 314 of workflow sentinel 316 via step signaling API 318. Step signal receiver 314, workflow sentinel 316, and step signaling API 318 may be, for example, step signal receiver 210, workflow sentinel 208, and step signaling API 224 in FIG. 2.

Step signal receiver 314 forwards the received step signal data to step tracker 320. Step tracker 320 may be, for example, step tracker 212 in FIG. 2. Step tracker 320 generates a directed graph corresponding to workflow 300 based on the received step signal data. Step tracker 320 stores the directed graph corresponding to workflow 300 in workflow registry 322, such as workflow registry 214 in FIG. 2.

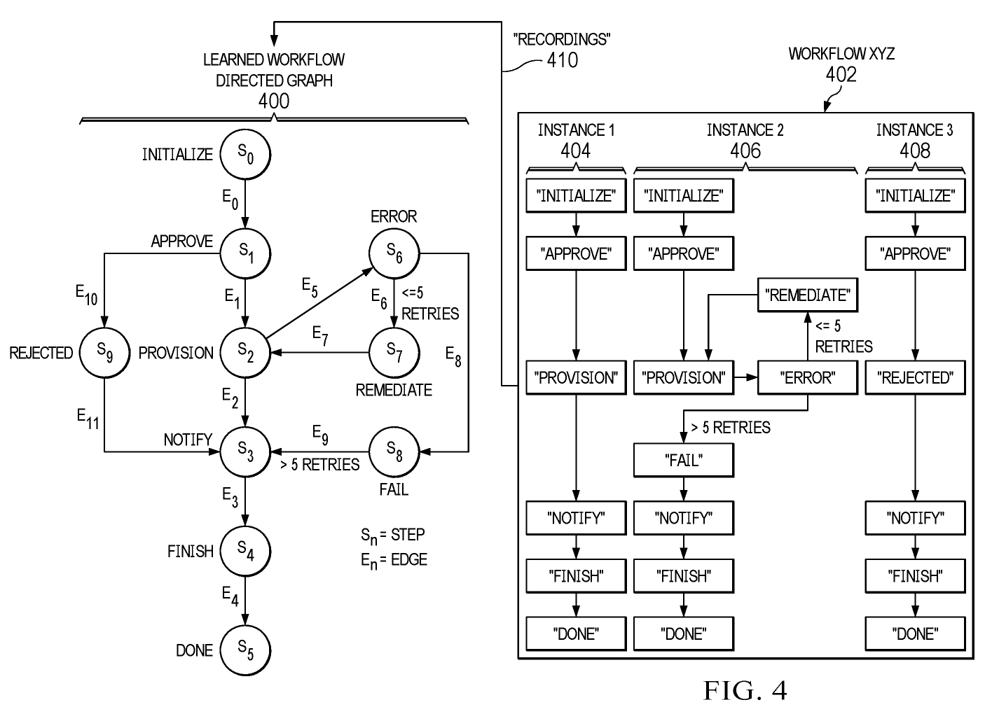

With reference now to FIG. 4, a diagram illustrating an example of a learned workflow directed graph is depicted in accordance with an illustrative embodiment. Learned workflow directed graph 400 is implemented by a workflow sentinel, such as workflow sentinel 208 in FIG. 2 or workflow sentinel 316 in FIG. 3.

In this example, learned workflow directed graph 400 is a data structure or model representing a learned workflow corresponding to workflow XYZ 402. In this example, workflow XYZ 402 has three running instances on a set of host systems. The three running instances of workflow XYZ 402 are instance 1404, instance 2406, and instance 3408. The workflow sentinel generates recordings 410 of instance 1404, instance 2406, and instance 3408 as instance 1404, instance 2406, and instance 3408 execute a given step.

In addition, the workflow sentinel generates learned workflow directed graph 400 based on recordings 410 of instance 1404, instance 2406, and instance 3408 of workflow XYZ 402. Learned workflow directed graph 400 is comprised of a plurality of nodes, each node corresponds to a respective step executed by instance 1404, instance 2406, and instance 3408. Further, each node is linked to a subsequent node via an edge representing the different variations between instance 1404, instance 2406, and instance 3408 of workflow XYZ 402.

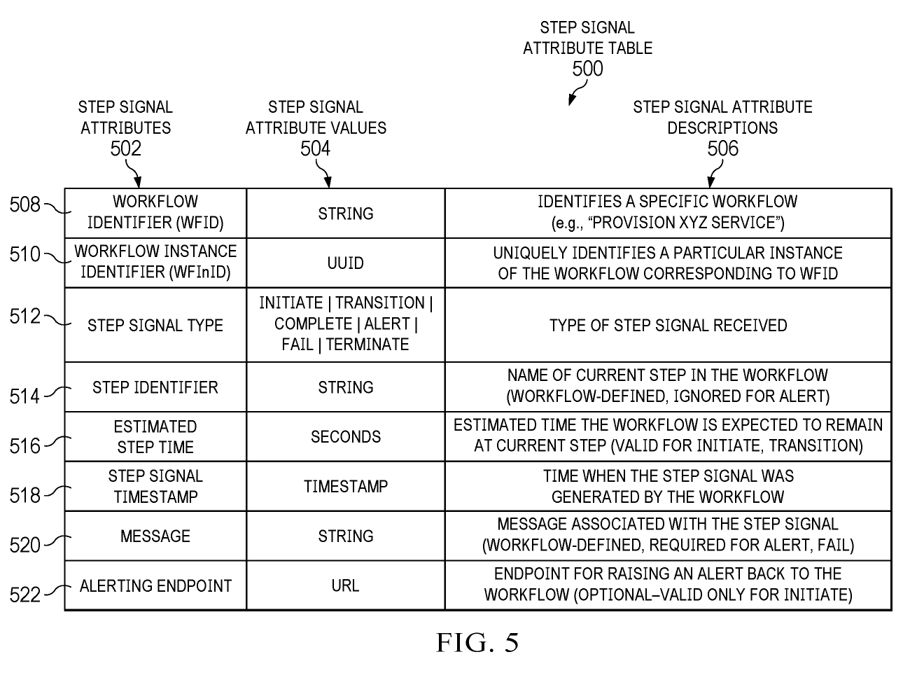

With reference now to FIG. 5, a diagram illustrating an example of a step signal attribute table is depicted in accordance with an illustrative embodiment. Step signal attribute table 500 is implemented by, for example, a step tracker, such as step tracker 320 in FIG. 3.

In this example, step signal attribute table 500 records step signal attributes 502, step signal attribute values 504, and step signal attribute descriptions 506. Also in this example, step signal attributes 502 include workflow identifier 508, workflow instance identifier 510, step signal type 512, step identifier 514, estimated step time 516, step signal timestamp 518, message 520, and alerting endpoint 522.

Workflow identifier 508 is a string value that identifies a specific workflow, such as a workflow to provision XYZ service. Workflow instance identifier 510 is a universally unique identifier (UUID) that uniquely identifies a particular instance of the workflow corresponding to workflow identifier 508.

Step signal type 512 is one of initiate, transition, complete, alert, fail, and terminate indicating the type of step signal received by a step signal receiver, such as step signal receiver 314 in FIG. 3. The initiate step signal type causes the step signal receiver to instantiate a new instance of the workflow corresponding to workflow identifier 508. The step signal receiver marks the new instance of the workflow as “active.” In addition, the step signal receiver generates workflow identifier 508 and workflow instance identifier 510 for the new instance of the workflow for tracking the new workflow instance. Further, the step signal receiver links the new instance of the workflow to a learned workflow of that same workflow using workflow identifier 508 if a learned workflow currently exists. Otherwise, the step signal receiver generates a new workflow.

Furthermore, the step signal receiver generates a first node of a directed graph corresponding to the new instance of the workflow, along with step identifier 514 for the node representing a name of the current step in the workflow. The step signal receiver also records estimated step time 516, step signal timestamp 518, and a received timestamp in properties of the node. Estimated step time 516 may be, for example, in seconds and indicates an estimated time the workflow is expected to remain at the current step. Step signal timestamp 518 is a timestamp indicating a time when the workflow generated the step signal. The received timestamp records when the step signal receiver received the step signal.

The transition step signal type indicates that the instance of the workflow corresponding to workflow instance identifier 510 has successfully transitioned to a next step in the workflow. As a result, the step signal receiver generates another node corresponding to the next step in the directed graph and names that node with a corresponding step identifier 514. The step signal receiver also links the next step to the previous step in the workflow. In addition, the step signal receiver records estimated step time 516, step signal timestamp 518, and the received timestamp in properties of that node.

The complete step signal type indicates a special transition case where the instance of the workflow has been successfully completed. As a result, the step signal receiver marks the instantiated workflow as “complete.” Further, the step signal receiver generates a final node for that final step in the directed graph of the workflow and names the final node with a corresponding step identifier 514. In addition, the step signal receiver links the final step to the previous step in the workflow. Furthermore, the step signal receiver records estimated step time 516 as infinite (-1), step signal timestamp 518, and the received timestamp in properties of that node.

The alert step signal type indicates that the instance of the workflow has message 520 corresponding to the current step being executed in the workflow. The current step in the instantiated workflow does not change. In other words, the step signal receiver does not generate a new node for the current step in the directed graph of the workflow. The step signal receiver records message 520 corresponding to the current step, step signal timestamp 518, and the received timestamp in node properties corresponding to the current step. Alerting endpoint 522 is a uniform resource locator (URL) identifying the endpoint for raising an alert, such as alert 219 in FIG. 2, back to the workflow.

The fail step signal type indicates that the instance of the workflow has failed. It should be noted that the step signal receiver associates the failure with the current step being executed in the workflow. The step signal receiver marks the instantiated workflow as “failed.” The step signal receiver does not generate a new node for the current step in the directed graph of the workflow. The step signal receiver records the failure, step signal timestamp 518, and the received timestamp in node properties corresponding to the current step.

The terminate step signal type indicates that the instance of the workflow has been proactively terminated at the current step. Thus, the step signal receiver associates the termination with the current step. The step signal receiver marks the instantiated workflow as “terminated.” However, it should be noted that the terminate step signal does not necessarily indicate an error has occurred in the current step. The step signal receiver does not generate a new node for the current step in the directed graph of the workflow. The step signal receiver records the termination, step signal timestamp 518, and the received timestamp in node properties corresponding to the current step.

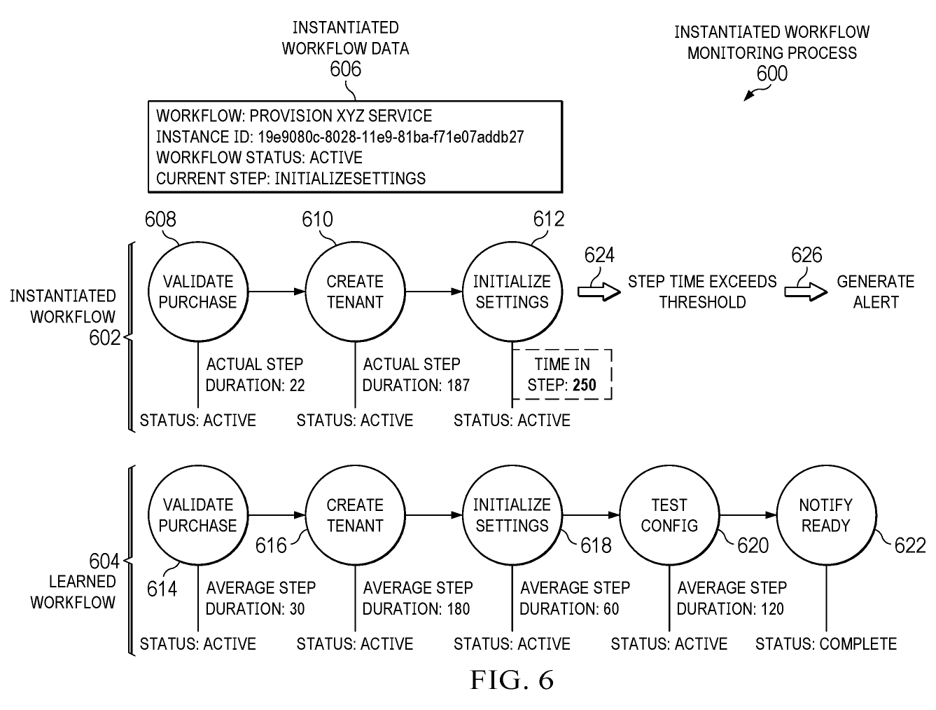

With reference now to FIG. 6, a diagram illustrating an example of an instantiated workflow monitoring process is depicted in accordance with an illustrative embodiment. Instantiated workflow monitoring process 600 is implemented by, for example, a workflow sentinel, such as workflow sentinel 208 in FIG. 2.

In this example, instantiated workflow monitoring process 600 includes instantiated workflow 602, learned workflow 604, and instantiated workflow data 606. Instantiated workflow data 606 identify a particular workflow (e.g., provision XYZ service), the specific instance of that particular workflow (i.e., instantiated workflow 602), status (e.g., active) of that specific instance, and current step (e.g., initialize settings) being executed by that specific instance.

The workflow sentinel monitors instantiated workflow 602 based on instantiated workflow data 606. In this example, instantiated workflow 602 includes validate purchase step 608, create tenant step 610, and initialize settings step 612, which is the step currently being executed in instantiated workflow 602.

The workflow sentinel also retrieves learned workflow 604 from a workflow registry, such as workflow registry 214 in FIG. 2. Learned workflow 604 represents a previously executed instance of the workflow provision XYZ service. The workflow sentinel compares instantiated workflow 602 with learned workflow 604 to determine whether any variations or changes exist in instantiated workflow 602. In this example, learned workflow 604 includes validate purchase step 614, create tenant step 616, initialize settings step 618, test configuration step 620, and notify ready step 622, which is a complete step signal.

It should be noted that validate purchase step 608, create tenant step 610, and initialize settings step 612 of instantiated workflow 602 are the same as validate purchase step 614, create tenant step 616, and initialize settings step 618 of learned workflow 604. However, at 624, the workflow sentinel detects that step time duration of initialize settings step 612 in instantiated workflow 602 is exceeding a maximum step time duration corresponding to initialize settings step 612. At 626, in response to detecting that initialize settings step 612 has exceeded the maximum step time duration, the workflow sentinel generates an alert, such as alert 219 in FIG. 2.

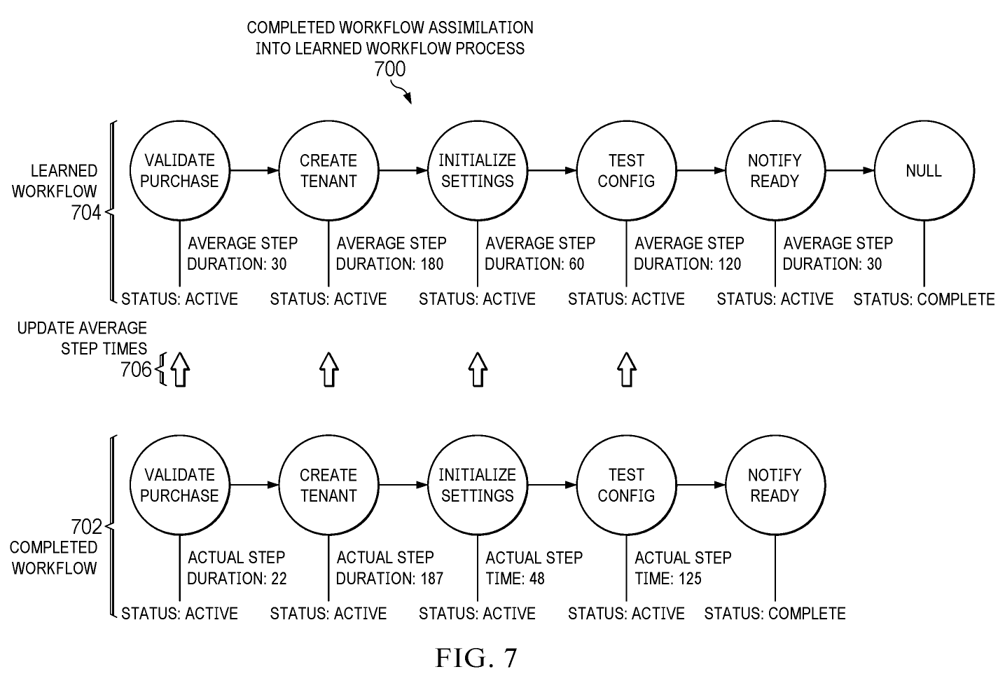

With reference now to FIG. 7, a diagram illustrating an example of a completed workflow assimilation into a learned workflow process is depicted in accordance with an illustrative embodiment. Completed workflow assimilation into learned workflow process 700 may be implemented by, for example, a workflow sentinel, such as workflow sentinel 208 in FIG. 2.

In this example, completed workflow assimilation into learned workflow process 700 includes completed workflow 702 and learned workflow 704. Completed workflow 702 may be, for example, a completed instance of instantiated workflow 602 in FIG. 6. In other words, completed workflow 702 represents a specific instance of a particular workflow that has completed executing all of its steps.

Learned workflow 704 may be, for example, learned workflow 604 in FIG. 6. Learned workflow 704 represents a previously learned instance of that particular workflow corresponding to completed workflow 702. At 706, the workflow sentinel updates the average step time duration of each respective step in learned workflow 704 based on the step time duration of corresponding steps in completed workflow 702.

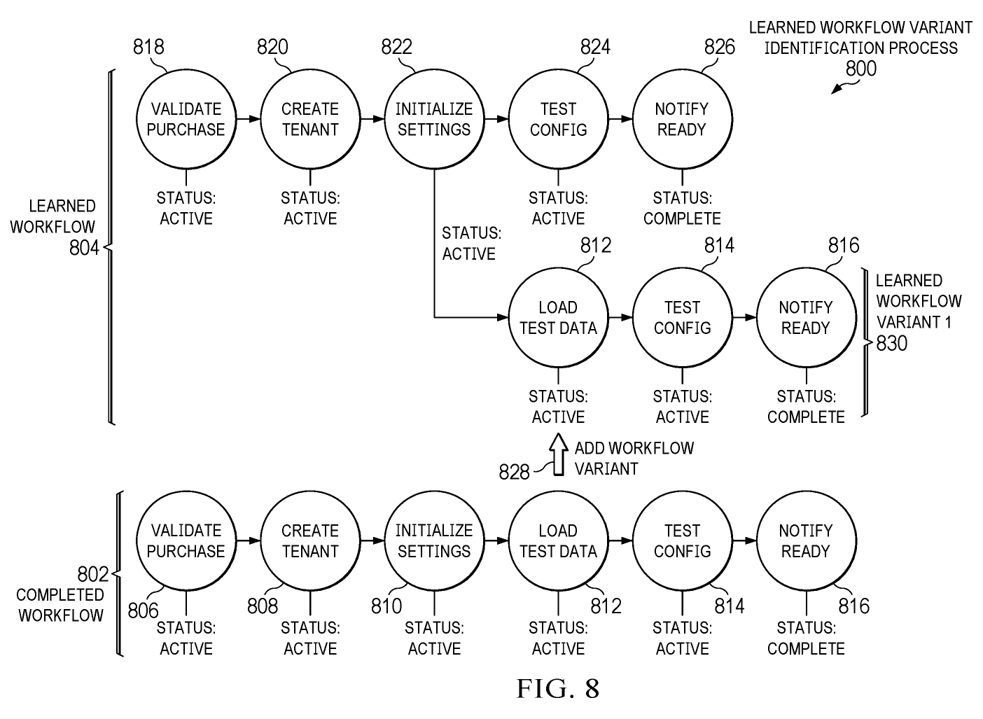

With reference now to FIG. 8, a diagram illustrating an example of a learned workflow variant identification process is depicted in accordance with an illustrative embodiment. Learned workflow variant identification process 800 may be implemented by, for example, a workflow sentinel, such as workflow sentinel 208 in FIG. 2.

In this example, learned workflow variant identification process 800 includes completed workflow 802 and learned workflow 804. In this example, completed workflow 802 includes validate purchase step 806, create tenant step 808, initialize settings step 810, load test data step 812, test configuration step 814, and notify ready step 816. It should be noted that completed workflow 802 is similar to completed workflow 702 in FIG. 7 except completed workflow 802 includes an added load test data step (i.e., load test data step 812). Learned workflow 804 is similar to learned workflow 704 in FIG. 7 and includes validate purchase step 818, create tenant step 820, initialize settings step 822, test configuration step 824, and notify ready step 826.

However, the workflow sentinel detects that completed workflow 802 is a variant of learned workflow 804 by executing added load test data step 812. Consequently, at 828, in response to detecting the workflow variant, the workflow sentinel adds the workflow variant to learned workflow 804 to form learned workflow variant 1830. In this example, learned workflow variant 1830 includes load test data step 812, test configuration step 814, and notify ready step 816 of completed workflow 802.

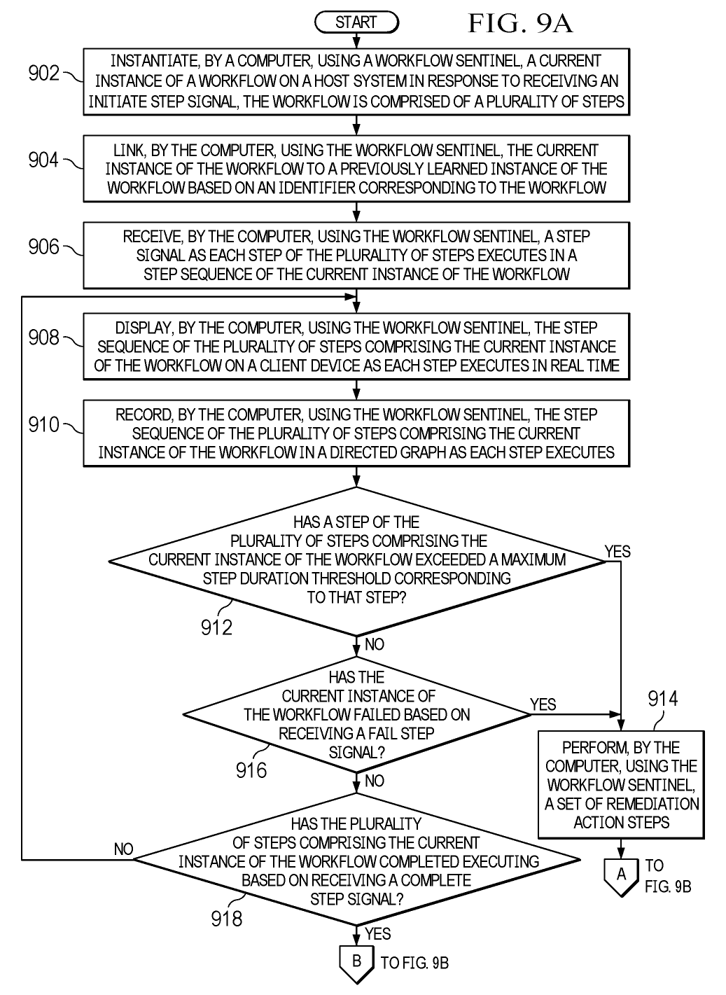

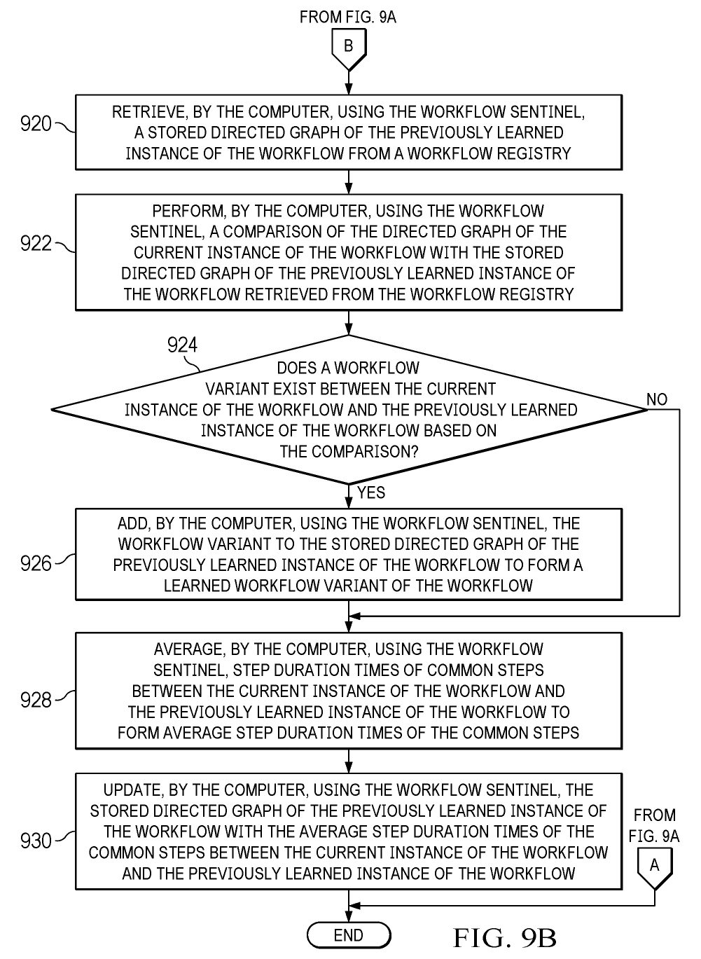

With reference now to FIGS. 9A-9B, a flowchart illustrating a process for managing workflows is shown in accordance with an illustrative embodiment. The process shown in FIGS. 9A-9B may be implemented in a computer, such as, for example, computer 101 in FIG. 1 or server 202 in FIG. 2. For example, the process shown in FIGS. 9A-9B may be implemented by workflow management code 200 in FIG. 1 or workflow sentinel 208 in FIG. 2.

The process begins when the computer, using the workflow sentinel, instantiates a current instance of a workflow on a host system in response to receiving an initiate step signal (step 902). The workflow is comprised of a plurality of steps. In response to instantiating the current instance of the workflow on the host system, the computer, using the workflow sentinel, links the current instance of the workflow to a previously learned instance of the workflow based on an identifier corresponding to the workflow (step 904).

Subsequently, the computer, using the workflow sentinel, receives a step signal as each step of the plurality of steps executes in a step sequence of the current instance of the workflow (step 906). The computer, using the workflow sentinel, displays the step sequence of the plurality of steps comprising the current instance of the workflow on a client device as each step executes in real time (step 908). In addition, the computer, using the workflow sentinel, records the step sequence of the plurality of steps comprising the current instance of the workflow in a directed graph as each step executes (step 910).

The computer, using the workflow sentinel, makes a determination as to whether a step of the plurality of steps comprising the current instance of the workflow has exceeded a maximum step duration threshold corresponding to that step (step 912). If the computer, using the workflow sentinel, determines that a step of the plurality of steps comprising the current instance of the workflow has exceeded the maximum step duration threshold corresponding to that step, yes output of step 912, then the computer, using the workflow sentinel, performs a set of remediation action steps (step 914). The set of remediation action steps includes, for example, at least one of sending an alert to a user via a client device, automatically performing a corrective action to remediate the issue, automatically terminating a network connection corresponding to the current instance of the workflow, and the like. Thereafter, the process terminates.

If the computer, using the workflow sentinel, determines that a step of the plurality of steps comprising the current instance of the workflow has not exceeded the maximum step duration threshold corresponding to that step, no output of step 912, then the computer, using the workflow sentinel, makes a determination as to whether the current instance of the workflow has failed based on receiving a fail step signal (step 916). If the computer, using the workflow sentinel, determines that the current instance of the workflow has failed based on receiving the fail step signal, yes output of step 916, then the process returns to step 914 where the computer, using the workflow sentinel, performs a set of remediation action steps.

If the computer, using the workflow sentinel, determines that the current instance of the workflow has not failed, no output of step 916, then the computer, using the workflow sentinel, makes a determination as to whether the plurality of steps comprising the current instance of the workflow has completed executing based on receiving a complete step signal (step 918). If the computer, using the workflow sentinel, determines that the plurality of steps comprising the current instance of the workflow has not completed executing, no output of step 918, then the process returns to step 908 where the computer, using the workflow sentinel, continues to display the step sequence on the client device in real time.

If the computer, using the workflow sentinel, determines that the plurality of steps comprising the current instance of the workflow has completed executing based on receiving a complete step signal, yes output of step 918, then the computer, using the workflow sentinel, retrieves a stored directed graph of the previously learned instance of the workflow from a workflow registry (step 920). The computer, using the workflow sentinel, performs a comparison of the directed graph of the current instance of the workflow with the stored directed graph of the previously learned instance of the workflow retrieved from the workflow registry (step 922).

The computer, using the workflow sentinel, makes a determination as to whether a workflow variant exists between the current instance of the workflow and the previously learned instance of the workflow based on the comparison (step 924). If the computer, using the workflow sentinel, determines that a workflow variant does not exist between the current instance of the workflow and the previously learned instance of the workflow based on the comparison, no output of step 924, then the process proceeds to step 928. If the computer, using the workflow sentinel, determines that a workflow variant does exist between the current instance of the workflow and the previously learned instance of the workflow based on the comparison, yes output of step 924, then the computer, using the workflow sentinel, adds the workflow variant to the stored directed graph of the previously learned instance of the workflow to form a learned workflow variant of the workflow (step 926).

Further, the computer, using the workflow sentinel, averages step duration times of common steps between the current instance of the workflow and the previously learned instance of the workflow to form average step duration times of the common steps (step 928). Furthermore, the computer, using the workflow sentinel, updates the stored directed graph of the previously learned instance of the workflow with the average step duration times of the common steps between the current instance of the workflow and the previously learned instance of the workflow (step 930). Thereafter, the process terminates.

Thus, illustrative embodiments of the present disclosure provide a computer-implemented method, computer system, and computer program product for managing workflows. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:instantiating, by a computer, a current instance of a workflow on a host system;executing, by the computer, the current instance of the workflow on the host system to form a current executing instance of the workflow on the host system;receiving, by the computer, via a step signaling application programming interface, a step signal as each step of a plurality of steps executes in a step sequence of the current executing instance of the workflow from the host system;displaying, by the computer, via an introspection application programming interface, the step sequence of the plurality of steps comprising the current executing instance of the workflow in a format that is capable of being presented in a user interface on a client device as each step executes in real time on the host system;recording, by the computer, the step sequence of the plurality of steps comprising the current executing instance of the workflow in a directed graph of the current executing instance of the workflow as each step executes in real time on the host system;performing, by the computer, using a step tracker and a correlator, a comparison of the directed graph of the current executing instance of the workflow with a stored directed graph of a previously learned instance of the workflow;determining, by the computer, whether a workflow variant exists between the current executing instance of the workflow and the previously learned instance of the workflow based on the comparison; andresponsive to determining that the workflow variant does exist between the current executing instance of the workflow and the previously learned instance of the workflow based on the comparison, adding, by the computer, the workflow variant to the stored directed graph of the previously learned instance of the workflow to form a learned workflow variant of the workflow.

2. The computer-implemented method of claim 1, further comprising:averaging, by the computer, step duration times of common steps between the current executing instance of the workflow and the previously learned instance of the workflow to form average step duration times of the common steps; andupdating, by the computer, the stored directed graph of the previously learned instance of the workflow with the average step duration times of the common steps between the current executing instance of the workflow and the previously learned instance of the workflow.

3. The computer-implemented method of claim 1, further comprising:linking, by the computer, the current executing instance of the workflow to the previously learned instance of the workflow based on an identifier corresponding to the workflow.

4. (canceled)

5. The computer-implemented method of claim 1, further comprising:determining, by the computer, whether a step of the plurality of steps comprising the current executing instance of the workflow has exceeded a maximum step duration threshold corresponding to that step; andresponsive to determining that the step of the plurality of steps comprising the current executing instance of the workflow has exceeded the maximum step duration threshold corresponding to that step, performing, by the computer, a set of remediation action steps.

6. The computer-implemented method of claim 5, further comprising:responsive to determining that a step of the plurality of steps comprising the current executing instance of the workflow has not exceeded the maximum step duration threshold corresponding to that step, determining, by the computer, whether the current executing instance of the workflow has failed based on receiving a fail step signal; andresponsive to determining that the current executing instance of the workflow has failed based on receiving the fail step signal, performing, by the computer, the set of remediation action steps.

7. The computer-implemented method of claim 6, further comprising:responsive to determining that the current executing instance of the workflow has not failed, determining, by the computer, whether the plurality of steps comprising the current executing instance of the workflow has completed executing based on receiving a complete step signal; andresponsive to determining that the plurality of steps comprising the current executing instance of the workflow has completed executing based on receiving the complete step signal, retrieving, by the computer, the stored directed graph of the previously learned instance of the workflow from a workflow registry.

8. A computer system comprising:a processor set;one or more computer-readable storage media; andprogram instructions stored on the one or more computer-readable storage media to cause the processor set to perform operations comprising:instantiating a current instance of a workflow on a host system;executing the current instance of the workflow on the host system to form a current executing instance of the workflow on the host system;receiving, via a step signaling application programming interface, a step signal as each step of a plurality of steps executes in a step sequence of the current executing instance of the workflow from the host system;displaying, via an introspection application programming interface, the step sequence of the plurality of steps comprising the current executing instance of the workflow in a format that is capable of being presented in a user interface on a client device as each step executes in real time on the host system;recording the step sequence of the plurality of steps comprising the current executing instance of the workflow in a directed graph of the current executing instance of the workflow as each step executes in real time on the host system;
performing, using a step tracker and a correlator, a comparison of the directed graph of the current executing instance of the workflow with a stored directed graph of a previously learned instance of the workflow;
determining whether a workflow variant exists between the current executing instance of the workflow and the previously learned instance of the workflow based on the comparison; and
responsive to determining that the workflow variant does exist between the current executing instance of the workflow and the previously learned instance of the workflow based on the comparison, adding the workflow variant to the stored directed graph of the previously learned instance of the workflow to form a learned workflow variant of the workflow.

9. The computer system of claim 8, wherein the operations further comprise:averaging step duration times of common steps between the current executing instance of the workflow and the previously learned instance of the workflow to form average step duration times of the common steps; andupdating the stored directed graph of the previously learned instance of the workflow with the average step duration times of the common steps between the current executing instance of the workflow and the previously learned instance of the workflow.

10. The computer system of claim 8, wherein the operations further comprise:linking the current executing instance of the workflow to the previously learned instance of the workflow based on an identifier corresponding to the workflow.

11. (canceled)

12. The computer system of claim 8, wherein the operations further comprise:
determining whether a step of the plurality of steps comprising the current executing instance of the workflow has exceeded a maximum step duration threshold corresponding to that step; and
responsive to determining that the step of the plurality of steps comprising the current executing instance of the workflow has exceeded the maximum step duration threshold corresponding to that step, performing a set of remediation action steps.

13. The computer system of claim 12, wherein the operations further comprise:responsive to determining that a step of the plurality of steps comprising the current executing instance of the workflow has not exceeded the maximum step duration threshold corresponding to that step, determining whether the current executing instance of the workflow has failed based on receiving a fail step signal; andresponsive to determining that the current executing instance of the workflow has failed based on receiving the fail step signal, performing the set of remediation action steps.

14. A computer program product comprising:one or more computer-readable storage media; andprogram instructions stored on the one or more computer-readable storage media to perform operations comprising:instantiating, by a computer, a current instance of a workflow on a host system;executing, by the computer, the current instance of the workflow on the host system to form a current executing instance of the workflow on the host system;receiving, by the computer, via a step signaling application programming interface, a step signal as each step of a plurality of steps executes in a step sequence of the current executing instance of the workflow from the host system;displaying, by the computer, via an introspection application programming interface, the step sequence of the plurality of steps comprising the current executing instance of the workflow in a format that is capable of being presented in a user interface on a client device as each step executes in real time on the host system;
recording, by the computer, the step sequence of the plurality of steps comprising the current executing instance of the workflow in a directed graph of the current executing instance of the workflow as each step executes in real time on the host system;
performing, by the computer, using a step tracker and a correlator, a comparison of the directed graph of the current executing instance of the workflow with a stored directed graph of a previously learned instance of the workflow;
determining, by the computer, whether a workflow variant exists between the current executing instance of the workflow and the previously learned instance of the workflow based on the comparison; and
responsive to determining that the workflow variant does exist between the current executing instance of the workflow and the previously learned instance of the workflow based on the comparison, adding, by the computer, the workflow variant to the stored directed graph of the previously learned instance of the workflow to form a learned workflow variant of the workflow.

15. The computer program product of claim 14, wherein the operations further comprise:averaging, by the computer, step duration times of common steps between the current executing instance of the workflow and the previously learned instance of the workflow to form average step duration times of the common steps; andupdating, by the computer, the stored directed graph of the previously learned instance of the workflow with the average step duration times of the common steps between the current executing instance of the workflow and the previously learned instance of the workflow.

16. The computer program product of claim 14, wherein the operations further comprise:linking, by the computer, the current executing instance of the workflow to the previously learned instance of the workflow based on an identifier corresponding to the workflow.

17. (canceled)

18. The computer program product of claim 14, wherein the operations further comprise:determining, by the computer, whether a step of the plurality of steps comprising the current executing instance of the workflow has exceeded a maximum step duration threshold corresponding to that step; andresponsive to determining that the step of the plurality of steps comprising the current executing instance of the workflow has exceeded the maximum step duration threshold corresponding to that step, performing, by the computer, a set of remediation action steps.

19. The computer program product of claim 18, wherein the operations further comprise:responsive to determining that a step of the plurality of steps comprising the current executing instance of the workflow has not exceeded the maximum step duration threshold corresponding to that step, determining, by the computer, whether the current executing instance of the workflow has failed based on receiving a fail step signal; andresponsive to determining that the current executing instance of the workflow has failed based on receiving the fail step signal, performing, by the computer, the set of remediation action steps.

20. The computer program product of claim 19, wherein the operations further comprise:responsive to determining that the current executing instance of the workflow has not failed, determining, by the computer, whether the plurality of steps comprising the current executing instance of the workflow has completed executing based on receiving a complete step signal; andresponsive to determining that the plurality of steps comprising the current executing instance of the workflow has completed executing based on receiving the complete step signal, retrieving, by the computer, the stored directed graph of the previously learned instance of the workflow from a workflow registry.
